(19) United States
(12) Patent Application Publication
(10) Pub. No.: US 2010/0256262 A1
(43) Pub. Date: Oct. 7, 2010

(54) RESIN COMPOSITION AND MOLDED BODY USING THE SAME

(75) Inventors: Tatsunori Masaki, Kyoto (JP); Yohei Kabashima, Kyoto (JP); Ken-ichi Kawada, Kyoto (JP); Hiroo Kamikawa, Kyoto (JP); Sachiko Kokuryo, Kyoto (JP)

Correspondence Address: FILDES & OUTLAND, P.C., 20916 MACK AVENUE, SUITE 2, GROSSE POINTE WOODS, MI, 48236, US

(73) Assignee: UNITIKA LTD., Hyogo (JP)

(21) Appl. No.: 12/675,854

(22) PCT Filed: Aug. 29, 2008
(86) PCT No.: PCT/JP2008/002354

§ 371 Date: Mar. 1, 2010

(30) Foreign Application Priority Data
Sep. 3, 2007 (JP) 2007-227808

(51) Int. Cl. C08L 77/00; C08K 5/51; C08K 3/34; C08L 97/02

(52) U.S. Cl. 524/9; 524/606; 524/133; 524/442

(57) ABSTRACT

Disclosed is a resin composition including a thermoplastic resin (A), a glass fiber (B) having a ratio of the major axis to the minor axis of the fiber cross section of 1.5 to 10 and a flame retardant (C), wherein the mass ratio (A/B) of the thermoplastic resin (A) to the glass fiber (B) is 30/70 to 95/5, and a part or the whole of the thermoplastic resin (A) is composed of a polyamide 11 resin (A1a) or/and a polyamide 1010 resin (A1b); and the resin composition includes 10 parts by mass or more of the polyamide 11 resin (A1a) or/and the polyamide 1010 resin (A1b) and 5 to 40 parts by mass of the flame retardant (C) in relation to 100 parts by mass of the total amount of the thermoplastic resin (A) and the glass fiber (B).

### TECHNICAL FIELD

The present invention relates to a resin composition and a molded body using the same, in particular, an environment-friendly thermoplastic resin composition and a molded body using the same.

### BACKGROUND ART

As the molding materials for the enclosures for use in electronic devices such as laptop personal computers, cellular phones and OA devices and molding materials for others, thermoplastic resins, namely, polycarbonate (PC) resin and acrylonitrile-butadiene-styrene copolymer (ABS) resin have been used. These resins easily undergo plastic deformation when an impactive load is applied thereto, so as to absorb the impact energy, and hence the enclosures of electronic devices are hardly broken.

Recently, such electronic device products as described above have been increasingly demanded to be thinner in wall, smaller in size and lighter in weight. Accordingly, the molding materials for product enclosures are required to have, as essential properties thereof, in addition to high impact strength, low specific gravity to reduce the product weight and high rigidity to reduce the deflection under load; and further, low warping property of the molded products is also essential. However, the enclosure-molding materials having been used generally do not satisfy the demanded performances, for example, in such a way that a high impact resistance is combined with a poor thin-wall moldability.

Accordingly, as an enclosure-molding material, for thin-wall portable devices, having overcome the above-described problems, there has been developed a resin composition prepared by mixing a liquid crystal polymer, a compatibilizer and an inorganic filler with a resin composition including a polyamide resin and a modified polyphenylene ether resin (JP6-240132A). However, this resin composition is insufficient in impact resistance and in low warping property.

Alternatively, there has been attempted an improvement of the rigidity, toughness and dimensional stability by mixing a fibrous reinforcing material with a base material prepared by mixing together an aromatic polyamide, an amorphous polyamide and polyamide 6 (JP2004-168849A). However, this attempt has not yet succeeded in imparting a practically satisfactory rigidity and a practically satisfactory toughness. In this document, JP2004-168849A, no description is found on the low warping property of the molded product.

On the other hand, recently, from the viewpoint of the environmental preservation, plant-derived thermoplastic resins such as polylactic acid resins, polyamide 11 resins and polyamide 1010 resins have been attracting attention.

Specifically, polylactic acid resins can be produced by using as starting materials plants such as corn and sweet potato, and can contribute to the saving of the exhaustive resources such as petroleum. Additionally, polylactic acid resins are crystalline polymers, and are higher in melting point and higher in heat resistance as compared to other biodegradable resins. Moreover, polylactic acid resins can be mass-produced, and hence are low in production cost and high in usefulness.

However, polylactic acid resins are slow in the crystallization rate, and hence are long in the molding cycle. Moreover, polylactic acid resins have drawbacks such that the molded bodies obtained from polylactic acid resins are poor in mechanical strength, impact resistance, flexibility and durability. Accordingly, for the purpose of solving such problems, there have been performed studies on the improvements of the heat resistance, impact resistance and durability of the molded bodies by mixing with a polylactic acid resin, for example, another petroleum-based biodegradable resin having more excellent performances than the polylactic acid resin and a hydrolysis inhibitor (JP2002-309074A, JP2006-321988A). However, even such a resin composition is long in molding cycle, and is insufficient in all the durability, impact resistance, flexibility and heat resistance.

On the other hand, polyamide 11 resins and polyamide 1010 resins are more excellent in the properties such as flexibility and durability as compared to polylactic acid resins, and are used in various industrial fields as applied to horses, tubes and the like. Polyamide 11 resins and polyamide 1010 resins are also produced from plant-derived materials, and are preferable from the viewpoint of environmental consideration. Additionally, for the purpose of further expanding the application fields, there has been investigated an attainment of a rigidity by mixing glass fiber with a polyamide 11 resin (JP7-207154A). However, in such a case, warping of molded pieces and other unfavorable effects occur disadvantageously from the viewpoint of shape stability.

When a resin composition is used for enclosures of electronic devices, the resin composition is required to permit thin-wall formation and high-rigidity realization and is also required to have flame retardancy. Accordingly, the mixing of, as a flame retardant, a flame retardant such as a phosphinic acid compound has been proposed in combination with the mixing of glass fiber with the resin composition (JP2004-292532A, JP2006-037100A). Nevertheless, the problem involving the shape stability has not been solved yet.

Further, polyamide 11 resins are high in price and hence are hardly spread in wide applications. For example, in the field of automobiles, polyamide 11 resins are used only in restricted areas according to need. For general molded products related to automobiles, general-purpose resins including polypropylene resins have been widely used because of the lowness in price thereof and the like. Additionally, although polyamide 11 resins are derived from plant, the amount of the carbon dioxide generated in the production process is not low, and equivalent to or more than the amount of the carbon dioxide generated in the case of each of the general-purpose resins such as polyolefin. This also offers a problem in achieving the use of polyamide 11 resins in wide areas.

### DISCLOSURE OF THE INVENTION

### Problems to be Solved by the Invention

An object of the present invention is to provide an environment-friendly thermoplastic resin composition which solves the above-described problems, is high in rigidity and low in warping property, is excellent in heat resistance, impact resistance and moldability, and has flame retardancy.

### Means for Solving the Problems

The present inventors made a continuous diligent study in order to solve the above-described problems, and consequently have reached the present invention by discovering that the above-described problems are solved by a resin composition including a polyamide 11 resin or/and a polyamide 1010 resin, a glass fiber having an oblate cross section and a flame retardant.

Specifically, the subject matter of the present invention is as follows.

(1) A resin composition including a thermoplastic resin (A), a glass fiber (B) having a ratio of the major axis to the minor axis of the fiber cross section of 1.5 to 10 and a flame retardant (C),

wherein the mass ratio (A/B) of the thermoplastic resin (A) to the glass fiber (B) is 30/70 to 95/5, and a part or the whole of the thermoplastic resin (A) is composed of a polyamide 11 resin (A1a) or/and a polyamide 1010 resin (A1b); and

the resin composition includes 10 parts by mass or more of the polyamide 11 resin (A1a) or/and the polyamide 1010 resin (A1b) and 5 to 40 parts by mass of the flame retardant (C) in relation to 100 parts by mass of the total amount of the thermoplastic resin (A) and the glass fiber (B).

(2) The resin composition according to (1), wherein a part of the thermoplastic resin (A) is composed of a modified polyolefin resin (A2), and the content of the modified polyolefin resin (A2) is 5 to 85 parts by mass in relation to 100 parts by mass of the total amount of the thermoplastic resin (A) and the glass fiber (B).

(3) The resin composition according to (2), wherein the modified polyolefin resin (A2) is a copolymer of a modified ethylene and/or a modified propylene and an α-olefin.

(4) The resin composition according to any one of (1) to (3), wherein a part of the thermoplastic resin (A) is composed of a polylactic acid resin (A3), and the content of the polylactic acid resin (A3) is 5 to 45 parts by mass in relation to 100 parts by mass of the total amount of the thermoplastic resin (A) and the glass fiber (B).

(5) The resin composition according to any one of (1) to (4), wherein the flame retardant (C) is a metal phosphinate.

(6) The resin composition according to any one of (1) to (5), wherein the resin composition includes a layered silicate (D) and the content of the layered silicate (D) is 0.1 to 45 parts by mass in relation to 100 parts by mass of the total amount of the thermoplastic resin (A) and the glass fiber (B).

(7) The resin composition according to any one of (1) to (6), wherein the resin composition includes a plant-derived filler (E) and the content of the plant-derived filler (E) is 5 to 200 parts by mass in relation to 100 parts by mass of the total amount of the thermoplastic resin (A) and the glass fiber (B).

(8) The resin composition according to (7), wherein the plant-derived filler (E) is composed of one or more selected from a jute fiber, a kenaf fiber, a bamboo fiber, a hemp fiber and a bagasse fiber.

(9) A molded body produced by molding the resin composition according to any one of (1) to (8).

### ADVANTAGES OF THE INVENTION

The present invention can provide a thermoplastic resin composition which is a thermoplastic resin composition having a high plant-derived proportion, is high in moldability, heat resistance and impact resistance, and is provided with a high rigidity and flame retardancy. The use of this resin composition for the components and the like of electric appliances can widely expand the application range of the low environmental load material, namely, a polyamide 11 resin or/and a polyamide 1010 resin. Accordingly, the present invention is extremely valuable in industrial applications.

### BEST MODE FOR CARRYING OUT THE INVENTION

Hereinafter, the present invention is described in detail.

The resin composition of the present invention is a resin composition including a thermoplastic resin (A), a glass fiber (B) and a flame retardant (C), and a part of or the whole of the thermoplastic resin (A) is required to be composed of a polyamide 11 resin (A1a) or/and a polyamide 1010 resin (A1b).

In the present invention, examples of the polyamide 11 resin (A1a) include a resin obtained by using ricinoleic acid in natural castor oil as a raw material and by condensation polymerization of ricinoleic acid with 11-aminoundecanoic acid. The production method of the polyamide 11 resin (A1a) is not particularly limited, and the polyamide 11 resin (A1a) can be produced according to a known method. In the production of the polyamide 11 resin (A1a), additives such as various catalysts and heat stabilizers may be used. Commercially available examples of the polyamide 11 resin (A1a) include “Rilsan BMN O” manufactured by Arkema Inc.

In the present invention, the polyamide 1010 resin (A1b) is a resin obtained by using natural castor oil as a raw material and by condensation polymerization of sebacic acid and decanediamine. The production method of the polyamide 1010 resin (A1b) is not particularly limited, and the polyamide 1010 resin (A1b) can be produced according to a known method. In the production of the polyamide 1010 resin (A1b), additives such as various catalysts and heat stabilizers may be used. In consideration of environmental load, the polyamide 1010 resin (A1b) preferably has a biomass carbon content of 50% or more as measured according to ASTM (D6866).

The polyamide 11 resin (A1a) and the polyamide 1010 resin (A1b) can be used each alone, and can also be used in combination with each other as the case may be.

In the resin composition of the present invention, the content of the polyamide 11 resin (A1a) or/and the polyamide 1010 resin (A1b) is required to be 10 parts by mass or more in relation to 100 parts by mass of the total amount of the thermoplastic resin (A) and the glass fiber (B). When the content of these polyamide resins is less than 10 parts by mass, it may be impossible to make the most of the excellent mechanical properties of these polyamide resins, and the plant-derived proportion of the resin composition is also insufficient.

In the resin composition of the present invention, the whole of the thermoplastic resin (A) may be composed of the polyamide 11 resin (A1a) or/and the polyamide 1010 resin (A1b), or alternatively the thermoplastic resin (A) may also include as a part thereof a modified polyolefin resin (A2). The inclusion of the modified polyolefin resin (A2) enables the cost reduction while the physical properties of the polyamide 11 resin (A1a) or/and the polyamide 1010 resin (A1b) are being maintained, and the impact resistance of the molded body can be improved.

As the modified polyolefin resin (A2), various products inclusive of commercially available products can be used. Specific examples of the modified polyolefin resin (A2) include a copolymer between a modified ethylene and/or a modified propylene and an α-olefin; a copolymer between an olefin mainly composed of an ethylene component and/or a propylene component and an α,β-unsaturated carboxylic acid or a derivative thereof; or a graft polymer obtained by grafting an olefin polymer mainly composed of an ethylene component and/or a propylene component with an α,β-unsaturated carboxylic acid or a derivative thereof.

Here, examples of the α,β-unsaturated carboxylic acid include acrylic acid, methacrylic acid, maleic acid, fumaric acid, itaconic acid, citraconic acid, crotonic acid and Nadic acid (endo-cis-bicyclo[2.2]hept-5-ene-2,3-dicarboxylic acid). Examples of the derivatives of the α,β-unsaturated carboxylic acid include acid halides, esters, amides, imides and anhydrides; specifically, malenyl chloride, maleimide, acrylic acid amide, methacrylic acid amide, glycidyl methacrylate, maleic acid anhydride, citraconic acid anhydride, monomethyl maleate, dimethyl maleate and glycidyl maleate. These can be used each alone or in combinations of two or more thereof. Preferable among these is maleic acid anhydride because maleic acid anhydride has a high reactivity and hence can result in production of molded products satisfactory both in strength and exterior appearance.

As the modified polyolefin resin (A2), preferable among the above-described modified polyolefin resins (A2) is a copolymer between a modified ethylene and/or a modified propylene and an α-olefin because of being large in impact resistance effect. Commercially available examples of such a modified polyolefin resins (A2) include “Toughmer” (trade name for a series of products such as a modified ethylene-α-olefin copolymer) manufactured by Mitsui Chemicals Inc.

The content of the modified polyolefin resin (A2) in the resin composition is preferably 5 to 85 parts by mass in relation to 100 parts by mass of the total amount of the thermoplastic resin (A) and the glass fiber (B). When the content is less than 5 parts by mass, no sufficient effects may be obtained. When the modified polyolefin resin (A2) is mixed in a content exceeding 85 parts by mass, the heat resistance may come to be poor.

The resin composition of the present invention may include as a part thereof a polylactic acid resin (A3). The inclusion of the polylactic acid resin (A3) enables the suppression of whisker formation at the time of molding so as to result in the improvement of the dimensional accuracy. As the polylactic acid resin (A3), polylactic acid resins obtained by using various plants such as corn as starting materials can be used, and when such a polylactic acid resin is used, the plant-derived proportion can be maintained high in addition to the improvement of the dimensional accuracy.

As the polylactic acid resin (A3), from the viewpoints of heat resistance and the moldability, poly(L-lactic acid), poly(D-lactic acid), and the mixtures or the copolymers of these can be used.

The content of the polylactic acid resin (A3) in the resin composition is preferably 5 to 45 parts by mass in relation to 100 parts by mass of the total amount of the thermoplastic resin (A) and the glass fiber (B). When the content of the polylactic acid resin (A3) is less than 5 parts by mass, the suppression of whisker formation at the time of molding so as to improve the dimensional accuracy is impossible. When the content exceeds 45 parts by mass, the impact resistance may be degraded.

The polylactic acid resin (A3) is preferably a polylactic acid resin in which a crosslinked structure is formed by a peroxide and/or a (meth)acrylic acid ester compound. The formation of such a crosslinked structure can improve the degree of crystallization at the time of molding and the heat resistance of the molded body.

In the present invention, as the thermoplastic resin (A), thermoplastic resins other than the above-described modified polyolefin resins (A2) and the above-described polylactic acid resins (A3) can also be used. When such thermoplastic resins are used, aliphatic biodegradable polyester resins are preferably used from the viewpoint of the environmental preservation.

The aliphatic biodegradable polyester resin is not particularly limited, and may be polymers of oxyacids or polyesters mainly composed of glycol and an aliphatic dicarboxylic acid, or mixtures or copolymers of these. Examples of the oxyacid component include glycolic acid and ε-caprolactone. Examples of glycol include ethylene glycol, 1,4-butanediol, 1,6-hexanediol, decamethylene glycol and neopentyl glycol. Examples of the aliphatic dicarboxylic acid include succinic acid, adipic acid, suberic acid, sebacic acid, dodecane diacid and anhydrides of these. The above-described oxyacids, glycols and aliphatic dicarboxylic acids can be used in optional combinations. Among these, polyethylene succinate, polybutylene succinate, polybutylene adipate and the like are preferable, and polybutylene succinate is more preferable.

The resin composition of the present invention is required to include a glass fiber (B). The glass fiber (B) is required to have an oblate cross section such that the ratio of the major axis to the minor axis of the fiber cross section is 1.5 to 10, and the ratio of the major axis to the minor axis is preferably 2.0 to 6.0. When the ratio of the major axis to the minor axis is less than 1.5, the effect due to the oblate shape of the cross section is small, and when the ratio exceeds 10, the production of such a glass fiber itself is difficult.

In the glass fiber (B), the major axis of the fiber cross section is preferably 10 to 50 μm, more preferably 15 to 40 μm and furthermore preferably 20 to 35 μm.

The ratio (aspect ratio) of the average fiber length to the average fiber diameter of the glass fiber (B) is preferably 2 to 120, more preferably 2.5 to 70 and furthermore preferably 3 to 50. When the aspect ratio is less than 2, the improvement effect of the mechanical strength is small, and when the aspect ratio exceeds 120, the anisotropy comes to be large and additionally, the exterior appearance of the molded product is degraded. The average fiber diameter of the glass fiber means the number average fiber diameter based on the perfect circles obtained by converting each of the oblate cross sections into the corresponding perfect circle having the same area as the area of the concerned oblate cross section.

In the present invention, as the glass fiber (B), a fiber having the composition of a common glass such as E-glass can be used. Any composition can be used as long as a glass fiber can be produced from the composition, and the glass composition is not particularly limited.

The glass fiber (B) is produced by a known method for producing glass fiber. The glass fiber (B) may include additives such as: at least one coupling agent such as a silane coupling agent, a titanium-based coupling agent and a zirconia-based coupling agent for the purpose of improving the adhesion with the matrix resin and uniform dispersibility; an antistatic agent; and a coating forming agent. The glass fiber (B) is sized with a sizing agent appropriate for the resin with which the glass fiber (B) is to be mixed, the sized glass fiber strands are collected and cut to a predetermined length to produce chopped strands, and thus, the glass fiber (B) is used in the form of the chopped strands.

In the resin composition of the present invention, the mass ratio (A/B) of the thermoplastic resin (A) to the glass fiber (B) is required to be 30/70 to 95/5, is preferably 35/65 to 75/25 and more preferably 40/60 to 70/30. When the proportion of the glass fiber (B) is less than 5% by mass, the warping of the molded product is large. On the other hand, when the proportion exceeds 70% by mass, the exterior appearance of the molded body is degraded and the production of the resin composition is difficult.

The resin composition of the present invention is required to include a flame retardant (C).

In the present invention, the compounds usable as the flame retardant (C) is not particularly limited; however, examples of the flame retardant (C) include various boric acid-based flame retardant compounds, phosphorus-based flame retardant compounds, inorganic flame retardant compounds, nitrogen-based flame retardant compounds, halogen-based flame retardant compounds, organic flame retardant compounds and colloidal flame retardant compounds. Two or more of these flame retardants may be used.

Examples of the boric acid-based flame retardant compound include boric acid-containing compounds such as zinc borate hydrate, barium metaborate and borax.

Examples of the phosphorus-based flame retardant compound include: phosphorus-containing compounds such as ammonium phosphate, ammonium polyphosphate, melamine phosphate, red phosphorus, phosphoric acid esters, tris(chloroethyl) phosphate, tris(monochloropropyl) phosphate, tris(dichloropropyl) phosphate, triallyl phosphate, tris(3-hydroxypropyl) phosphate, tris(tribromophenyl) phosphate, tris-β-chloropropyl phosphate, tris(dibromophenyl) phosphate, tris(tribromoneopentyl) phosphate, tetrakis(2-chloroethyl)ethylene diphosphate, dimethyl phosphate, tris(2-chloroethyl) orthophosphate, aromatic condensed phosphoric acid esters, halogen-containing condensed organic phosphoric acid esters, ethylene bis tris(2-cyanoethyl)phosphonium bromide, β-chloroethyl acid phosphate, butyl pyrophosphate, butyl acid phosphate, butoxyethyl acid phosphate, 2-ethylhexyl acid phosphate, melamine phosphoric acid salt, halogen-containing phosphonates, phenyl phosphoric acid, metal phosphinates and phosphinic acid esters.

Examples of the inorganic flame retardant compound include: metal sulfate compounds such as zinc sulfate, potassium hydrogen sulfate, aluminum sulfate, antimony sulfate, sulfuric acid esters, potassium sulfate, cobalt sulfate, sodium hydrogen sulfate, iron sulfate, copper sulfate, sodium sulfate, nickel sulfate, barium sulfate and magnesium sulfate; ammoniac flame retardant compounds such as ammonium sulfate; iron oxide-based combustion catalysts such as ferrocene; metal nitrate compounds such as copper nitrate; titanium-containing compounds such as titanium oxide; guanidine compounds such as guanidine sulfaminate; zirconium compounds; molybdenum compounds; tin compounds; carbonate compounds such as potassium carbonate; metal hydroxides such as aluminum hydroxide and magnesium hydroxide; and modified products of these compounds.

Examples of the nitrogen-based flame retardant compounds include triazine ring-containing cyanurate compounds.

Examples of the halogen-based flame retardant compound include: halogen-containing flame retardant compounds such as chlorinated paraffin, perchlorocyclopentadecane, hexabromobenzene, decabromodiphenyl oxide, bis(tribromophenoxy)ethane, ethylene bis-dibromonorbornane dicarboxyimide, ethylene bis-tetrabromophthalimide, dibromoethyl dibromocyclohexane, dibromoneopentyl glycol, 2,4,6-tribromophenol, tribromophenyl allyl ether, tetrabromo bisphenol A derivatives, tetrabromo bisphenol S derivatives, tetradecabromo diphenoxybenzene, tris-(2,3-dibromopropyl)-isocyanurate, 2,2-bis(4-hydroxy-3,5-dibromophenyl)propane, 2,2-bis(4-hydroxyethoxy-3,5-dibromophenyl)propane, poly(pentabromobenzyl acrylate), tribromostyrene, tribromophenyl maleimide, tribromoneopentyl alcohol, tetrabromodipentaerythritol, pentabromobenzyl acrylate, pentabromophenol, pentabromotoluene, pentabromodiphenyl oxide, hexabromocyclododecane, hexabromodiphenyl ether, octabromophenol ether, octadibromodiphenyl ether, octabromodiphenyl oxide, dibromoneopentyl glycol tetracarbonate, bis(tribromophenyl)fumaramide, N-methylhexabromodiphenylamine, styrene bromide and diallyl chlorendate.

Examples of the organic flame retardant compound include: chlorendic acid anhydride; phthalic acid anhydride, bisphenol A-containing compounds; glycidyl compounds such as glycidyl ether; polyhydric alcohols such as diethylene glycol and pentaerythritol; modified carbamides; and silica-based compounds such as silicone oil, silicon dioxide, low-melting point glass and organosiloxanes.

Examples of the colloidal flame retardant compound include compounds having flame retardancy and having been used for a long time. Specific examples of the colloidal flame retardant include colloids of the following flame retardant compounds: hydroxides such as aluminum hydroxide, magnesium hydroxide and calcium hydroxide; hydrates such as calcium aluminate, gypsum dihydrate, zinc borate, barium metaborate, borax and kaolin clay; nitric acid compounds such as sodium nitrate; molybdenum compounds; zirconium compounds; antimony compounds; dawsonite; and progopite.

As the flame retardant (C) in the present invention, in particular, preferable are the flame retardants which do not impose load on the environment when discarded in such a way that the flame retardants do not generate toxic gases at the time of incineration thereof. From such an environment-friendly viewpoint, it is preferable to use, as the flame retardant (C) in the present invention, phosphorus-based compounds such as metal phosphinates and phosphinic acid esters; hydroxide compounds such as aluminum hydroxide, magnesium hydroxide and calcium hydroxide; and silica-based compounds such as silicon dioxide, low-melting point glass and organosiloxane. Particularly preferable among these are the metal phosphinates that are phosphorus-based compounds.

The metal phosphinate means a compound produced in an aqueous solution by using phosphinic acids represented by the following formula (I) and/or the following formula (II), and a metal carbonate, a metal hydroxide or a metal oxide. The metal phosphinate is intrinsically present as a monomer. However, depending on the reaction conditions, the metal phosphinate may be present as a polymeric phosphinate having a degree of condensation of 1 to 3. Examples of the phosphinic acid include dimethyl phosphinic acid, ethyl methyl phosphinic acid, diethyl phosphinic acid, methyl-n-propyl phosphinic acid, methanedi(methylphosphinic acid), benzene-1,4-(dimethyl phosphinic acid), methyl phenyl phosphinic acid and diphenyl phosphinic acid. Examples of the metal carbonate, metal hydroxide or metal oxide include the corresponding compounds that include a calcium ion, a magnesium ion, an aluminum ion and/or a zinc ion.

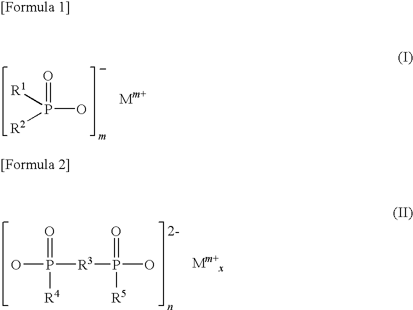

In formula (I) and formula (II), R¹, R⁴, R² and R⁵ are each linear or branched C₁ to C₁₆ alkyl, preferably C₁ to C₈ alkyl, in particular methyl, ethyl, n-propyl, isopropyl, n-butyl, tert-butyl, n-pentyl, n-octyl and phenyl. R¹ and R² may form together a ring, and R⁴ and R⁵ may form together a ring. R³ is linear or branched C₁ to C₁₀ alkylene, in particular methylene, ethylene, n-propylene, isopropylene, isopropylidene, n-butylene, tert-butylene, n-pentylene, n-octylene and n-dodecylene; arylene, in particular phenylene and naphthylene; alkylarylene, in particular methylphenylene, ethylphenylene, tert-butylphenylene, methylnaphthylene, ethylnaphthylene and tert-butylnaphthylene; and arylalkylene, in particular phenylmethylene, phenylethylene, phenylpropylene and phenylbutylene. M represents a calcium ion or an aluminium ion; m is 2 or 3, n is 1 or 3, and x is 1 or 2; and in formula (II), m multiplied by x is 2n.

Examples of the above-described metal phosphinate include calcium dimethylphosphinate, magnesium dimethylphosphinate, aluminium dimethylphosphinate, zinc dimethylphosphinate, calcium ethylmethylphosphinate, magnesium ethylmethylphosphinate, aluminium ethylmethylphosphinate, zinc ethylmethylphosphinate, calcium diethylphosphinate, magnesium diethylphosphinate, aluminium diethylphosphinate, zinc diethylphosphinate, calcium methyl-n-propylphosphinate, magnesium methyl-n-propylphosphinate, aluminium methyl-n-propylphosphinate and zinc methyl-n-propylphosphinate.

Alternatively, examples of the metal phosphinate also include calcium methanedi(methylphosphinate), magnesium methanedi(methylphosphinate), aluminium methanedi(methylphosphinate), zinc methanedi(methylphosphinate), calcium benzene-1,4-(dimethylphosphinate), magnesium benzene-1,4-(dimethylphosphinate), aluminium benzene-1,4-(dimethylphosphinate), zinc benzene-1,4-(dimethylphosphinate), calcium methylphenylphosphinate, magnesium methylphenylphosphinate, aluminium methylphenylphosphinate, zinc methylphenylphosphinate, calcium diphenylphosphinate, magnesium diphenylphosphinate, aluminium diphenylphosphinate, and zinc diphenylphosphinate. Among these, aluminium diethylphosphinate and zinc diethylphosphinate are preferable from the viewpoints of the flame retardancy and the electric properties.

In the resin composition of the present invention, the content of the flame retardant (C) is required to be 5 to 40 parts by mass and is preferably 15 to 25 parts by mass in relation to 100 parts by mass of the total amount of the thermoplastic resin (A) and the glass fiber (B). When the content of the flame retardant (C) is less than 5 parts by mass, the flame retardancy cannot be attained. On the other hand, when the content of the flame retardant (C) exceeds 40 parts by mass, the degradation of the mechanical strength and the degradation of the thermal properties occur.

In the present invention, a flame retardant aid (C′) may be used. Examples of the flame retardant aid (C′) include a reaction product between melamine and phosphoric acid and/or melamine cyanurate.

The reaction product between melamine and phosphoric acid is obtained from the substantially-equimolar reaction product between melamine and phosphoric acid, pyrophosphoric acid or polyphosphoric acid. The production method of the reaction product between melamine and phosphoric acid is not particularly constrained. Usually, examples of such a reaction product may include melamine polyphosphate obtained by the heat condensation of melamine phosphate in an atmosphere of nitrogen. Specific examples of the phosphoric acid for constituting melamine phosphate may include orthophosphoric acid, phosphorous acid, hypophosphorous acid, metaphosphoric acid, pyrophosphoric acid, triphosphoric acid and tetraphosphoric acid. Particularly preferable among the reaction products is melamine polyphosphate obtained by the condensation of the adduct between melamine and orthophosphoric acid or pyrophosphoric acid, from the viewpoint of the flame retardancy. The particle size of the reaction product between melamine and phosphoric acid is recommended to be 100 μm or less, preferably 50 μm or less, from the viewpoints of the mechanical strength and the exterior appearance of the molded product obtained by molding the resin composition of the present invention. Particularly preferably, the use of the powders having a particle size of 0.5 to 20 μm attains a high flame retardancy and additionally remarkably enhances the strength of the molded product.

Melamine cyanurate is the equimolar reaction product between cyanuric acid and melamine. For example, an aqueous solution of cyanuric acid and an aqueous solution of melamine are mixed together, the obtained mixed solution is allowed to react under stirring at a temperature of approximately 70 to 100° C., the obtained precipitate is filtered off, and thus melamine cyanurate can be obtained. The particle size of melamine cyanurate is preferably 100 μm or less, more preferably 50 μm or less, from the viewpoints of the mechanical properties and the exterior appearance of the molded product. It is recommended to use a powder obtained by milling the precipitate so as to have such a particle size. Particularly preferably, the use of a powder having a particle size of 0.5 to 20 μm attains a high flame retardancy and additionally remarkably enhances the strength of the molded product.

The mass ratio (C/C′) of the flame retardant (C) to the flame retardant aid (C′) is preferably 4 to 25 and more preferably 5 to 20. When this mass ratio is less than 4, the mechanical strength and the toughness tend to be degraded, and when this mass ratio exceeds 25, the flame retardancy is hardly attained.

The resin composition of the present invention may include a layered silicate (D). The inclusion of the layered silicate (D) enables to reduce the occurrence of burrs at the time of molding.

Examples of the usable layered silicate (D) include various materials such as montmorillonite, layered fluorine mica (synthetic mica), talc, mica and clay. Preferable among these are montmorillonite and/or layered fluorine mica (synthetic mica) from the viewpoints of the dimensional stability and others.

The addition of the layered silicate (D) is optimally performed at the time of polymerization of the thermoplastic resin (A). When such addition is difficult, it is preferable to chemically modify, before kneading, the layered silicate (D) with a quaternary ammonium salt or a phosphonium salt.

The content of the layered silicate (D) is preferably 0.1 to 45 parts by mass in relation to 100 parts by mass of the total amount of the thermoplastic resin (A) and the glass fiber (B). When the content is less than 0.1 part by mass, no sufficient effect may be obtained. When the layered silicate (D) is mixed in a content exceeding 45 parts by mass, adverse effects such as fluidity failure at the time of kneading/molding may occur.

The resin composition of the present invention may include a plant-derived filler (E). The inclusion of the plant-derived filler (E) enables the plant-derived proportion to be maintained high and the heat resistance of the molded product to be improved.

As the plant-derived filler (E), all plant-derived fillers can be used. As the form of the plant-derived filler (E), all forms of fillers such as a fibrous filler and a powdery filler can be used. Specific examples of the fibrous filler may include a jute fiber, a kenaf fiber, a bamboo fiber, a hemp fiber and a bagasse fiber. Specific examples of the powdery filler may include wood powder, bamboo powder, paper powder and common cellulose powder.

As the plant-derived filler (E), delignified fillers are preferably used. When non-delignified fillers are used, the exterior appearance and the durability may be adversely affected. As the delignification treatment, known methods may be appropriately applied. Examples of such known methods include a method based on a strong alkaline solution such as a sodium hydroxide solution or a potassium hydroxide solution, a method in which heating is conducted by using sodium hydroxide and sodium sulfide and a method in which a treatment is conducted with a molybdate and hydrogen peroxide under acidic conditions. By further applying bleaching in addition to the delignification treatment, the color development of lignin can be suppressed.

The content of the plant-derived filler (E) is preferably 5 to 200 parts by mass in relation to 100 parts by mass of the total amount of the thermoplastic resin (A) and the glass fiber (B). When the content is less than 5 parts by mass, no sufficient improvement effect of the heat resistance may be obtained, and the plant-derived proportion is also insufficient. When the plant-derived filler (E) is mixed in a content exceeding 200 parts by mass, the impact resistance may be degraded.

Not particularly limited is the technique for mixing the glass fiber (B) having an oblate cross section and the flame retardant (C) and for further mixing the layered silicate (D) and the plant-derived filler (E) with the thermoplastic resin (A) including the polyamide 11 resin (A1a) or/and the polyamide 1010 resin (A1b). Examples of such a technique include a method in which melt kneading is performed with a single screw extruder or a double screw extruder. The use of a double screw extruder is preferable in the sense that a satisfactory kneaded condition is to be attained. The kneading temperature preferably falls within a range from (the melting point of the polyamide 11 resin or the polyamide 1010 resin+5° C.) to (the melting point of the polyamide 11 resin or the polyamide 1010 resin+100° C.). The kneading time is preferably 20 seconds to 30 minutes. When the kneading temperature is lower than the above-described temperature range or the kneading time is shorter than the above-described time range, the kneading or the reaction may be insufficient. On the other hand, when the kneading temperature or the kneading time is respectively higher or longer than the corresponding range, the decomposition or the coloration of the resin may occur. For the purpose of ensuring the compatibility between the flame retardancy and the shape stability, preferably, after the materials other than the glass fiber (B) are sufficiently melt mixed, the glass fiber (B) is side fed in a predetermined amount and deaeration under reduced pressure is performed.

To the resin composition of the present invention, as long as the properties of the resin composition are not significantly impaired, additives such as a pigment, a heat stabilizer, an antioxidant, an antiweathering agent, a plasticizer, a lubricant, a release agent and an antistatic agent can be added. Examples of the heat stabilizer and the antioxidant include hindered phenols, hindered amines, sulfur compounds, copper compounds and alkali metal halides. The method for mixing these additives with the resin composition of the present invention is not particularly limited.

The resin composition of the present invention can be molded into various molded bodies by the molding methods such as injection molding, blow molding, extrusion molding and inflation molding, and by the molding methods, to be applied after processing into sheets, such as vacuum molding, pneumatic molding and vacuum-pneumatic molding. Among these, the injection molding method is preferably adopted. As the injection molding method, gas injection molding, injection press molding and the like can also be adopted in addition to the common injection molding method. An appropriate example of the injection molding conditions suitable for the resin composition of the present invention is such that the cylinder temperature is set at a temperature equal to or higher than the melting point or the flow initiation temperature of the resin composition, preferably at 190 to 270° C. and the die temperature is set at equal to or lower than (the melting point of the resin composition—20° C.). When the molding temperature is too low, the operability comes to be unstable in such a way that short shot occurs in the molded body, and overload tends to occur. On the other hand, when the molding temperature is too high, the resin composition is decomposed, and consequently the problems that the obtained molded body is degraded in strength and colored tend to occur.

Specific examples of the molded bodies include: various peripheral components of personal computers and the enclosures of such components; components of cellular phones and the enclosures of such components; resin components for the electric appliances such as other OA device components; agricultural materials such as containers and cultivation containers and resin components for agricultural machines; seafood business resin components such as floats and seafood processing containers; tableware such as plates, cups and spoons and food containers; medical resin components such as injectors and intravenous containers; resin components for housing/civil engineering/building materials such as drain materials, fences, storage boxes and building construction work switchboards; resin components for leisure and general merchandises such as cooler boxes, fans and toys; and resin components for vehicles such as bumpers, instrument panels and door trims. Examples of the molded bodies also include extrusion-molded products and hollow molded products such as films, sheets and pipes.

### EXAMPLES

Hereinafter, the present invention is more specifically described with the reference to Examples. The materials and the evaluation methods used for the following Examples and Comparative Examples are as follows.

(1) Materials

[Thermoplastic Resin (A)]

Polyamide 11 resin (A1a): Rilsan BMN O, manufactured by Arkema Inc.

Polyamide 1010 resin (A1b): In hot methanol, 100 parts by mass of sebacic acid (manufactured by Hokoku Corp.) was dissolved under stirring. In methanol, 85 parts by mass of decamethylene diamine (manufactured by Kokura Synthetic Industries, Ltd.) was dissolved, and the obtained solution was slowly added to the above-described methanol solution of sebacic acid. On completion of the addition of the methanol solution of decamethylene diamine, the resulting mixed solution was stirred for about 15 minutes, and the precipitate was filtered off and washed with methanol to yield decamethylene diammonium sebacate.

In an autoclave, 100 parts by mass of decamethylene diammonium sebacate and 33 parts by mass of water were placed, the air in the autoclave was replaced with nitrogen, and then heating was started at a temperature set at 240° C. under stirring at 25 rpm. The interior of the autoclave was maintained at a pressure of 2 MPa for 2 hours, and then the steam was discharged to decrease the pressure down to normal pressure. Successively, the contents of the autoclave were stirred under a pressure of normal pressure to 0.02 MPa for 2 to 3 hours, then were allowed to stand still for 1 hour, and then taken out. The reaction product thus obtained was dried under reduced pressure to yield the polyamide 1010.

Polyamide 66 resin: A142 manufactured by Unitika Ltd.

Modified polyolefin resin (A2a): A double screw extruder (TEM-37BS manufactured by Toshiba Machine Co., Ltd.) was used, and 90 parts by mass of polyethylene and 10 parts by mass of maleic acid anhydride were fed from a root feed opening of the extruder, and extrusion was performed, with a vent valve being operated, under the conditions that the barrel temperature was 180° C., the screw rotation number was 280 rpm and the discharge rate was 15 kg/h. Further, 0.2 part by mass of a peroxide, Perbutyl D (manufactured by NOF Corp.) was fed into the cylinder. Then the resin discharged from the end of the extruder was cut into a pellet shape, and the pellets of the resin composition were obtained. The obtained pellets were vacuum dried at 70° C. for 24 hours to yield a modified polyolefin resin (A2a).

Modified polyolefin resin (A2b): Modified ethylene-α-Olefin copolymer, Toughmer TX1250, manufactured by Mitsui Chemicals, Inc.

Polylactic acid (A3): Teramac TE-4000, manufactured by Unitika Ltd.

Crosslinked polylactic acid resin (A3′): A double screw extruder (TEM-37BS manufactured by Toshiba Machine Co., Ltd.) was used, and 100 parts by mass of polylactic acid resin (A3) was fed from a root feed opening of the extruder and extrusion was performed, with a vent valve being operated, under the conditions that the barrel temperature was 180° C., the screw rotation number was 280 rpm and the discharge rate was 15 kg/h. Further, 0.10 part by mass of ethylene glycol dimethacrylate and 0.2 part by mass of Perbutyl D were fed into the cylinder. Then the resin discharged from the end of the extruder was cut into a pellet shape, and thus the pellets of the resin composition were obtained. The obtained pellets were vacuum dried at 70° C. for 24 hours to yield a crosslinked polylactic acid resin (A3′).

[Glass Fiber (B)]

Oblate cross section glass fiber (B1): CSG3PA820S (oblate glass fiber with an oblate cross section having a major axis of 28 μm, a minor axis of 7 μm, and a ratio of major axis to minor axis of 4.0) manufactured by Nitto Boseki Co., Ltd.

Circular cross section glass fiber (B2): CS3J-451 (glass fiber with a circular cross section having a diameter of 10 μm and a length of 3 mm) manufactured by Nitto Boseki Co., Ltd.

[Flame Retardant (C)]

Flame retardant (C1): Aluminum diethylphosphinate

Flame retardant (C2): A mixture in which aluminum diethylphosphinate (flame retardant)/melamine polyphosphate (flame retardant aid)=80/20 (mass ratio)

[Layered Silicate (D)]

Layered silicate (D): Esben W manufactured by Hojun Co., Ltd.

[Plant-Derived Filler (E)]

Kenaf fiber (E1): A sample of kenaf was cut to a constant length of about 5 mm, and crushed and disentangled with a turbo mill (T-250, manufactured by Matsubo Corp.) so as to have a fiber diameter of 20 to 50 μm and a fiber length of 1 to 5 mm.

Kenaf fiber (E2): Kenaf fiber (E1) was subjected to a pressurizing and heating treatment by using a solution of sodium hydroxide to remove lignin, and thus Kenaf fiber (E2) was obtained.

(2) Evaluation Methods

(a) Flexural modulus: The flexural modulus was measured according to ASTM D790. The flexural modulus is preferably 2.0 GPa or more.

(b) Deflection temperature under load: The deflection temperature under load was measured according to ASTM D648, by measuring the thermal deformation temperature with a load of 0.45 MPa. The thermal deformation temperature is preferably 110° C. or higher.

(c) Izod impact value: The Izod impact value was measured according to ASTM D256-56. The Izod impact value is preferably 100 J/m or more.

(d) Warpage: A test piece was statically placed on a horizontal board, and the following four points were measured. As the test piece, a disc having a thickness of 1.6 mm and a diameter of 100 mmφ was used. The warpage is preferably 0.3 mm or less.

Warpages at reference points a, b: The warpages at the two points grounded on a horizontal board

Warpages at warping points c, d: The warpages at the points each being large in warping

Formula for calculation of warpage:

Warpage (mm)=(c+d)/2−(a+b)/2

(e) Sink depth: A plate of 4×6 inches (101.6×152.4 mm)×10 mm thickness was molded, the depth of each of the spots where sinks were formed was measured, and the average value of the measured depths was derived.

(f) Burr length: The die temperature was set at 85° C., and the molded product was maintained at the holding pressure of 100 MPa until the gate of the molded product was perfectly cooled and solidified, and thus the molded product was obtained. The maximum length of the burrs generated in the obtained molded product was measured and thus the burr length was obtained.

(g) Flame retardancy: The flame retardancy was measured according to the method of UL94 (Standard established by Under Writers Laboratories Inc., United States). The thickness of the specimen was set at 1/16 inch (about 1.6 mm). The flame retardancy is preferably V−1 or V−0. The case where the flame retardancy was lower than V−2 was marked with x.

(h) Hue: The L value of the resin composition pellets was measured by using Σ90 Color Measuring System manufactured by Nippon Denshoku Industries Co., Ltd., with a C/2 light source and in a reflection mode. The L value means the luminance. The L value is preferably 30 or more.

### Examples 1 to 24 and Comparative Examples 2 to 8

By using a double screw extruder (PCM 30, manufactured by Ikegai Corp.), a thermoplastic resin (A), a flame retardant (C), a layered silicate (D) and a plant-derived filler (E) were dry blended in the ratios shown in Table 1 or Table 2, and fed from the root feed opening of the extruder. Further, a glass fiber was fed from the side feed opening of the extruder in a ratio shown in Table 1 or Table 2, and the extrusion was performed, with a vent valve being operated, under the conditions that the barrel temperature was 240° C., the screw rotation number was 230 rpm and the discharge rate was 5 kg/h. The resin discharged from the end of the extruder was cut into a pellet shape, and thus the pellets of the resin composition of each of Examples 1 to 24 and Comparative Examples 2 to 8 were obtained.

After the obtained pellets of each of above-described Examples and Comparative Examples were vacuum dried at 90° C. for 24 hours, specimens (ASTM type) for general physical property measurements were prepared by using an injection molding machine IS-80G manufactured by Toshiba Machine Co., Ltd., while the die surface temperature was being regulated at 85° C.; the specimens were used for various measurements. Separately, the plates for the above-described sink depth measurement were molded in the same manner as described above, and after cooling, the sink depths were measured.

The measurement results are shown in Table 1 and Table 2.

### Comparative Example 1

As shown in Table 2, as the thermoplastic resin (A), only the polyamide 11 resin pellets were used, specimens (ASTM type) for general physical property measurements were prepared by using an injection molding machine IS-80G manufactured by Toshiba Machine Co., Ltd., while the die surface temperature was being regulated at 85° C.; the specimens were used for various measurements. Separately, the plate for the above-described sink depth measurement was molded in the same manner as described above, and after cooling, the sink depths were measured.

The measurement results are shown in Table 2.

TABLE 1

| | | | Examples | | | | | | | |
|---|---|---|---|---|---|---|---|---|---|---|
| | | | 1 | 2 | 3 | 4 | 5 | 6 | 7 | 8 |
| Composition | Thermoplastic | Polyamide 11 resin (A1a) | 70 | 70 | 70 | 50 | 90 | 30 | 65 | 65 |
| (parts by | resin (A) | Polyamide 1010 resin (A1b) | | | | | | | | |
| mass) | | Polyamide 66 resin | | | | | | | | |

| | | | |
|---|---|---|---|
| Modified polyolefin | A2a | | |
| resin | A2b | | |
| Polylactic acid resin | Non-crosslinked (A3) | 5 | |
| | Crosslinked (A3′) | | 5 |

| | | | | | | | | | |
|---|---|---|---|---|---|---|---|---|---|
| Glass fiber (B) | Oblate cross section glass fiber (B1) | 30 | 30 | 30 | 50 | 10 | 70 | 30 | 30 |
| | Circular cross section glass fiber (B2) | | | | | | | | |
| Flame retardant (C) | Flame retardant [without aid] (C1) | 20 | 10 | 35 | 20 | 20 | 20 | 20 | 20 |
| | Flame retardant [with aid] (C2) | | | | | | | | |

| Layered silicate (D) | |
|---|---|
| Plant-derived | Kenaf fiber (E1) |
| filler (E) | Kenaf fiber (E2) |

| | | | | | | | | | | |
|---|---|---|---|---|---|---|---|---|---|---|
| Evaluations | Plant-derived proportion | % by mass | 58 | 64 | 52 | 42 | 75 | 25 | 58 | 58 |
| | Resin component proportion | % by mass | 58 | 64 | 52 | 42 | 75 | 25 | 58 | 58 |
| | Flexural modulus | GPa | 5.8 | 5.6 | 5.1 | 7.0 | 2.7 | 10.0 | 5.9 | 6.2 |
| | Deflection temperature under load | ° C. | 163 | 161 | 161 | 170 | 138 | 175 | 153 | 162 |
| | Izod impact value | J/m | 140 | 160 | 115 | 120 | 150 | 70 | 110 | 110 |
| | Warpage | mm | 0.1 | 0.1 | 0.1 | 0.1 | 0.1 | 0 | 0.1 | 0.1 |
| | Sink depth | mm | 0.3 | 0.3 | 0.3 | 0.3 | 0.3 | 0.15 | 0.15 | 0.15 |
| | Burr length | mm | 0.2 | 0.2 | 0.15 | 0.2 | 0.2 | 0.1 | 0.25 | 0.25 |
| | Hue | L value | | | | | | | | |

| | | | | | | | | |
|---|---|---|---|---|---|---|---|---|
| Flame retardancy | V-1 | V-1 | V-1 | V-1 | V-1 | V-0 | V-1 | V-1 |

| | | | Examples | | | | | | | | |
|---|---|---|---|---|---|---|---|---|---|---|---|
| | | | 9 | 10 | 11 | 12 | 13 | 14 | 15 | 16 | 17 |
| Composition | Thermoplastic | Polyamide 11 resin (A1a) | 50 | 25 | 60 | 60 | 65 | 10 | 70 | 70 | 85 |
| (parts by | resin (A) | Polyamide 1010 resin (A1b) | | | | | | | | | |
| mass) | | Polyamide 66 resin | | | | | | | | | |

| | | | | | | | |
|---|---|---|---|---|---|---|---|
| Modified polyolefin | A2a | | | 10 | | | |
| resin | A2b | | | | 10 | 5 | 85 |
| Polylactic acid resin | Non-crosslinked (A3) | | | | | | |
| | Crosslinked (A3′) | 20 | 45 | | | | |

| | | | | | | | | | | |
|---|---|---|---|---|---|---|---|---|---|---|
| Glass fiber (B) | Oblate cross section glass fiber (B1) | 30 | 30 | 30 | 30 | 30 | 5 | 30 | 30 | 15 |
| | Circular cross section glass fiber (B2) | | | | | | | | | |
| Flame retardant (C) | Flame retardant [without aid] (C1) | 20 | 20 | 20 | 20 | 20 | 20 | 20 | 20 | 20 |
| | Flame retardant [with aid] (C2) | | | | | | | | | |

| Layered silicate (D) | | | |
|---|---|---|---|
| Plant-derived | Kenaf fiber (E1) | 25 | |
| filler (E) | Kenaf fiber (E2) | 10 | 125 |

| | | | | | | | | | | | |
|---|---|---|---|---|---|---|---|---|---|---|---|
| Evaluations | Plant-derived proportion | % by mass | 58 | 58 | 50 | 50 | 56 | 8 | 66 | 62 | 86 |
| | Resin component proportion | % by mass | 58 | 58 | 58 | 58 | 58 | 79 | 48 | 54 | 35 |
| | Flexural modulus | GPa | 6.4 | 6.5 | 4.1 | 4.0 | 5.2 | 2.1 | 5.1 | 4.9 | 5.3 |
| | Deflection temperature under load | ° C. | 153 | 144 | 151 | 150 | 157 | 110 | 168 | 165 | 143 |
| | Izod impact value | J/m | 75 | 55 | 185 | 205 | 155 | 250 | 115 | 115 | 100 |
| | Warpage | mm | 0.1 | 0.2 | 0.1 | 0.1 | 0.1 | 0.1 | 0.1 | 0.1 | 0.1 |
| | Sink depth | mm | 0.15 | 0.15 | 0.3 | 0.3 | 0.3 | 0.3 | 0.3 | 0.3 | 0.3 |
| | Burr length | mm | 0.3 | 0.4 | 0.2 | 0.2 | 0.2 | 0.2 | 0.2 | 0.2 | 0.2 |
| | Hue | L value | | | | | | | 24 | 43 | 35 |

| | | | | | | | | | |
|---|---|---|---|---|---|---|---|---|---|
| Flame retardancy | V-1 | V-1 | V-1 | V-1 | V-1 | V-1 | V-1 | V-1 | V-1 |

| | | | Examples | | | | | | |
|---|---|---|---|---|---|---|---|---|---|
| | | | 18 | 19 | 20 | 21 | 22 | 23 | 24 |
| Composition | Thermoplastic | Polyamide 11 resin (A1a) | 85 | 70 | 60 | 60 | 60 | 60 | |
| (parts by | resin (A) | Polyamide 1010 resin (A1b) | | | | | | | 70 |
| mass) | | Polyamide 66 resin | | | | | | | |

| | | | | | |
|---|---|---|---|---|---|
| Modified polyolefin | A2a | | | | |
| resin | A2b | 10 | 10 | 10 | 10 |
| Polylactic acid resin | Non-crosslinked (A3) | | | | |
| | Crosslinked (A3′) | | | | |

| | | | | | | | | |
|---|---|---|---|---|---|---|---|---|
| Glass fiber (B) | Oblate cross section glass fiber (B1) | 15 | 30 | 30 | 30 | 30 | 30 | 30 |
| | Circular cross section glass fiber (B2) | | | | | | | |
| Flame retardant (C) | Flame retardant [without aid] (C1) | 20 | | | | | | 20 |
| | Flame retardant [with aid] (C2) | | 20 | 25 | 25 | 25 | 25 | |

| | | | |
|---|---|---|---|
| Layered silicate (D) | 0.5 | 3 | 40 |

| | | |
|---|---|---|
| Plant-derived | Kenaf fiber (E1) | |
| filler (E) | Kenaf fiber (E2) | 180 |

| | | | | | | | | | |
|---|---|---|---|---|---|---|---|---|---|
| Evaluations | Plant-derived proportion | % by mass | 88 | 58 | 48 | 48 | 47 | 36 | 58 |
| | Resin component proportion | % by mass | 28 | 58 | 56 | 56 | 55 | 42 | 58 |
| | Flexural modulus | GPa | 6.0 | 5.8 | 4.7 | 5.0 | 5.2 | 6.1 | 6.0 |
| | Deflection temperature under load | ° C. | 178 | 160 | 155 | 155 | 159 | 169 | 167 |
| | Izod impact value | J/m | 80 | 140 | 195 | 196 | 200 | 220 | 135 |
| | Warpage | mm | 0.1 | 0.1 | 0.1 | 0 | 0 | 0 | 0.1 |
| | Sink depth | mm | 0.3 | 0.3 | 0.3 | 0.3 | 0.3 | 0.3 | 0.3 |
| | Burr length | mm | 0.1 | 0.2 | 0.2 | 0.1 | 0.1 | 0.1 | 0.2 |
| | Hue | L value | 32 | | | | | | |

| | | | | | | | |
|---|---|---|---|---|---|---|---|
| Flame retardancy | V-1 | V-0 | V-0 | V-0 | V-0 | V-0 | V-1 |

TABLE 2

| | | | Comparative Examples | | | | | | | |
|---|---|---|---|---|---|---|---|---|---|---|
| | | | 1 | 2 | 3 | 4 | 5 | 6 | 7 | 8 |
| Composition | Thermoplastic resin (A) | Polyamide 11 resin (A1a) | 100 | | 70 | 97 | 20 | 70 | 70 | 5 |
| (parts by | | Polyamide 1010 resin (A1b) | | | | | | | | |
| mass) | | Polyamide 66 resin | | 70 | | | | | | |

| | | |
|---|---|---|
| Modified polyolefin resin | A2a | |
| | A2b | 25 |
| Polylactic acid resin | Non-crosslinked (A3) | |
| | Crosslinked (A3') | |

| | | | | | | | | |
|---|---|---|---|---|---|---|---|---|
| Glass fiber (B) | Oblate cross section glass fiber (B1) | 30 | | 3 | 80 | 30 | 30 | 70 |
| | Circular cross section glass fiber (B2) | | 30 | | | | | |
| Flame retardant (C) | Flame retardant [without aid] (C1) | | 25 | 25 | 25 | | | 20 |
| | Flame retardant [with aid] (C2) | 25 | | | | 3 | 60 | |

| Layered silicate (D) | |
|---|---|
| Plant-derived filler (E) | Kenaf fiber (E1) |
| | Kenaf fiber (E2) |

| | | | | | | | | | | |
|---|---|---|---|---|---|---|---|---|---|---|
| Evaluations | Plant-derived proportion | % by mass | 100 | 0 | 56 | 78 | 16 | 68 | 44 | 4 |
| | Resin component proportion | % by mass | 100 | 56 | 56 | 78 | 16 | 68 | 44 | 25 |
| | Flexural modulus | GPa | 1.0 | 6.2 | 5.1 | 2.4 | 10 | 5.5 | 2.3 | 9.5 |
| | Deflection temperature under load | ° C. | 115 | 250 | 162 | 117 | 181 | 161 | 136 | 70 |
| | Izod impact value | J/m | 320 | 80 | 120 | 145 | 60 | 155 | 45 | 100 |
| | Warpage | mm | 0.1 | 1.5 | 1.1 | 2 | 0.1 | 0.1 | 0.1 | 0 |
| | Sink depth | mm | 0.3 | 0.3 | 0.3 | 0.3 | 0.3 | 0.3 | 0.3 | 0.15 |
| | Burr length | mm | 0.2 | 0.2 | 0.2 | 0.2 | 0.1 | 0.2 | 0.2 | 0.1 |
| | Hue | L value | | | | | | | | |

| | | | | | | | |
|---|---|---|---|---|---|---|---|
| Flame retardancy | V-0 | V-1 | V-1 | V-1 | x | V-0 | V-1 |

As can be seen from Tables 1 and 2, in each of Examples 1 to 24, the plant-derived material proportion was high, and the resin composition excellent in low warping property, rigidity and flame retardancy was obtained.

In each of Examples 7 to 10, the polylactic acid resin (A3) was mixed, and hence the molded products small in the degree of sink and high in the dimensional stability were obtained. In particular, in Example 8, the crosslinked polylactic acid resin (A3′) was used as the polylactic acid resin (A3), and hence a molded body more excellent in heat resistance was obtained as compared to Example 7 in which the non-crosslinked polylactic acid resin (A3) was used in the same amount.

In each of Examples 11 to 14 and 20 to 23, the modified polyolefin resin (A2) was mixed, and hence a molded product remarkably excellent in impact resistance was obtained. In particular, among these Examples, in each of Examples 12, 14 and 20 to 23, the modified polyolefin resin (A2b) was used in an appropriate amount, and hence a molded product particularly excellent in impact resistance was obtained.

In each of Examples 15 to 18, as the plant-derived filler (E), a kenaf fiber was mixed, and hence a molded product excellent in heat resistance was obtained. Moreover, as compared to Example 15, in the each of Examples 16 to 18, a delignified kenaf fiber (E2) was used, and hence more bright and excellent results were obtained in the exterior appearance of the molded product.

In each of Examples 19 to 23, the flame retardant (C) including a flame retardant aid was used, and hence results exhibiting extremely excellent flame retardancy were obtained.

In each of Examples 21 to 23, the layered silicate (D) was mixed, and hence a molded product having a small degree of warping and a small degree of burr formation and being excellent in the shape stability was obtained.

In Example 24, the polyamide 1010 resin (A1b) was used as the thermoplastic resin (A), and hence the same results as in above-described Example 1 and the like were obtained.

From these results, it has been found that by adding the glass fiber having an oblate cross section, the flame retardant, the modified polyolefin resin, the polylactic acid resin, the layered silicate and the kenaf fiber respectively in specific amounts to the polyamide 11 resin or the polyamide 1010 resin, the resin compositions being high in the plant-derived proportion, having a high rigidity, being high in impact resistance, flame retardancy and heat resistance, and having a low sink depth are obtained. Further, it has been found that by using a phosphinic acid salt as the flame retardant, a higher flame retardancy can be imparted.

In contrast to these Examples, the results for Comparative Examples are summarized as follows. Comparative Example 1 used a polyamide 11 resin as a single substance, and hence was economically remarkably disadvantageous. Comparative Example 2 used the petroleum-derived polyamide 66 resin, and hence was far from being environment-friendly. Comparative Examples 2 to 4 underwent large warping because the types or the mixing amounts of the used polyamide resins and the used glass fibers were inappropriate. Comparative Example 5 was too large in the mixing amount of the glass fiber, and hence was poor in processing operability. Comparative Example 6 was too low in the mixing amount of the flame retardant, and hence was not able to be provided with any flame retardant effect. Comparative Example 7 was too large in the mixing amount of the flame retardant, and hence resulted in poor strength, poor heat resistance and poor impact resistance, although the flame retardancy of Comparative Example 7 was V−0. Comparative Example 8 included a polyamide 11 resin only in an amount of 5% by mass in relation to 100 parts by mass of the total amount of the thermoplastic resin (A) and the glass fiber (B), and hence was far from being environment-friendly.

1. A resin composition comprising a thermoplastic resin (A), a glass fiber (B) having a ratio of a major axis to a minor axis of a fiber cross section of 1.5 to 10 and a flame retardant (C),
wherein a mass ratio (A/B) of the thermoplastic resin (A) to the glass fiber (B) is 30/70 to 95/5, and a part or a whole of the thermoplastic resin (A) is composed of a polyamide 11 resin (A1a) or/and a polyamide 1010 resin (A1b); and
the resin composition comprises 10 parts by mass or more of the polyamide 11 resin (A1a) or/and the polyamide 1010 resin (A1b) and 5 to 40 parts by mass of the flame retardant (C) in relation to 100 parts by mass of a total amount of the thermoplastic resin (A) and the glass fiber (B).

2. The resin composition according to claim 1, wherein a part of the thermoplastic resin (A) is composed of a modified polyolefin resin (A2), and a content of the modified polyolefin resin (A2) is 5 to 85 parts by mass in relation to 100 parts by mass of the total amount of the thermoplastic resin (A) and the glass fiber (B).

3. The resin composition according to claim 2, wherein the modified polyolefin resin (A2) is a copolymer of a modified ethylene and/or a modified propylene and an α-olefin.

4. The resin composition according to claim 1, wherein a part of the thermoplastic resin (A) is composed of a polylactic acid resin (A3), and a content of the polylactic acid resin (A3) is 5 to 45 parts by mass in relation to 100 parts by mass of the total amount of the thermoplastic resin (A) and the glass fiber (B).

5. The resin composition according to claim 1, wherein the flame retardant (C) is a metal phosphinate.

6. The resin composition according to claim 1, wherein the resin composition comprises a layered silicate (D) and a content of the layered silicate (D) is 0.1 to 45 parts by mass in relation to 100 parts by mass of the total amount of the thermoplastic resin (A) and the glass fiber (B).

7. The resin composition according to claim 1, wherein the resin composition comprises a plant-derived filler (E) and a content of the plant-derived filler (E) is 5 to 200 parts by mass in relation to 100 parts by mass of the total amount of the thermoplastic resin (A) and the glass fiber (B).

8. The resin composition according to claim 7, wherein the plant-derived filler (E) is composed of one or more selected from a jute fiber, a kenaf fiber, a bamboo fiber, a hemp fiber and a bagasse fiber.

9. A molded body produced by molding the resin composition according to claim 1.

10. A molded body produced by molding the resin composition according to claim 2.

11. A molded body produced by molding the resin composition according to claim 3.

12. A molded body produced by molding the resin composition according to claim 4.

13. A molded body produced by molding the resin composition according to claim 5.

14. A molded body produced by molding the resin composition according to claim 6.

15. A molded body produced by molding the resin composition according to claim 7.

16. A molded body produced by molding the resin composition according to claim 8.
